(19) United States
(12) Patent Application Publication
(10) Pub. No.: US 2012/0320562 A1
(43) Pub. Date: Dec. 20, 2012

(54) LED LIGHTING DEVICE

(75) Inventors: Chih-Hao LIN, Taipei City (TW); Cheng-Wei HUNG, Mao-Li County (TW); Kun-Hua WU, Hsinchu County (TW); Chao-Hsien WANG, Tainan City (TW); Po-Chang CHEN, Yunlin County (TW); Chih-Ping LO, Hsinchu County (TW); Po-Chang CHEN, Tainan City (TW)

(73) Assignee: WELLYPOWER OPTRONICS CORPORATION, Hsinchu County (TW)

(21) Appl. No.: 13/480,493

(22) Filed: May 25, 2012

(30) Foreign Application Priority Data
Jun. 15, 2011 (TW) 100120928

(51) Int. Cl. F21V 9/16

(52) U.S. Cl. 362/84

(57) ABSTRACT

An LED (Light-Emitting Diode) lighting device is provided. The LED lighting device comprises an LED module, a lamp cover, and a phosphor layer. The LED module comprises a circuit board comprising a driving circuit and a plurality of LEDs mounted on the circuit board and driven by the driving circuit so as to emit light of 300-700 nm in wavelength. The lamp cover is configured to shield the LED module. The phosphor layer is coated on an inner surface of the lamp cover towards the LED module and configured to transform the light of 300-700 nm in wavelength to a luminary light of 400-700 nm in wavelength.

### RELATED APPLICATIONS

The application claims priority to Taiwan Application Serial Number 100120928, filed Jun. 15, 2011, which is herein incorporated by reference.

### BACKGROUND

1. Field of Invention

The present invention relates to an LED (Light Emitting Diode) lighting device. More particularly, the present invention relates to an LED lighting device with LEDs emitting different spectrum.

2. Description of Related Art

An LED is a semiconductor element which generates light by releasing energy via the combination of holes and electrons. That is, to transform electric energy to optical energy. When a voltage is applied between a positive terminals and a negative terminal in a semiconductor, as current flows there through to combine electrons with holes, energy will be released out as light. The color of the light depends on the materials. Also, the energy level changes the color of the light. Further, when a positive voltage is applied, the LED can emit single-color light, discontinuous light, which is one of the photo-electric effects. The LED can emit near-ultraviolet light, visible light, or infrared light by changing the chemical composition of the semiconductor. To sum up, the LED is a new economical light source in the 21^{st} century and has advantages of high efficiency and long operation life, in comparison with the conventional light source.

Nowadays, various LED lamps appeared in the lighting market. However, it is still needed to improve the cost performance of the LED lamps and enhance the illumination effect of the LED lamps.

### SUMMARY

Hence, according to an embodiment of the present invention, an LED lighting device is provided. The LED lighting device comprises an LED module, a lamp cover, and a phosphor layer. The LED module comprises a circuit board comprising a driving circuit and a plurality of LEDs which are mounted on the circuit board and driven by the driving circuit so as to emit light of 300-700 nm in wavelength. The lamp cover is configured to shield the LED module. The phosphor layer is coated on an inner surface of the lamp cover towards the LED module and configured to transform the light of 300-700 nm in wavelength to luminary light of 400-700 nm in wavelength.

In the abovementioned embodiment, the LEDs emit light in different spectrums. For example, the LEDs comprise at least a blue LED, a red LED or a combination thereof.

According to another embodiment, the LEDs are mounted in a radial symmetrical way on the circuit board. Alternatively, the LEDs are mounted on the circuit board at unequal distances in accordance with another embodiment,

Still, according to another embodiment, the driving circuit comprises a current control unit configured to control current of each of the LEDs so as to adjust a magnitude of the light.

According to another embodiment, the lamp cover and the LED module form a closed space.

According to another embodiment, the lamp cover is a hemisphere and has a maximum diameter which is greater than a width of the LED module. Specifically, a base of the lamp cover may be connected to the circuit board of the LED module and a center of the lamp cover may be located above the circuit board of the LED module.

Therefore, in view of the LED lighting device provided by the present invention, the LEDs each of which emits light with a different spectrum but in the range of 300-700 nm in wavelength are utilized to work with the lamp cover and the corresponding phosphor layer. Thus, a flexible color light fixture can be implemented by using a light source with low cost. Moreover, the adjustment of the LED module and the lamp cover can also improve an illumination angle of the lighting device so as to generate a great benefit in the LED lighting market.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram showing an LED lighting device in accordance with a first embodiment of the present invention.

FIG. 2 is a schematic diagram showing an LED lighting device in accordance with the second embodiment of the present invention.

FIG. 3 is a schematic diagram showing an LED lighting device in accordance with the third embodiment of the present invention.

FIG. 4 is a schematic diagram showing an LED lighting device in accordance with the fourth embodiment of the present invention.

FIG. 5 is a schematic diagram showing an LED lighting device in accordance with the fifth embodiment of the present invention.

FIG. 6 is a schematic diagram showing the layout of the LEDs on the circuit board in application with any aforementioned embodiment.

FIG. 7 is a schematic diagram showing the spectrum of the LEDs of the LED module in application with any aforementioned embodiment.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

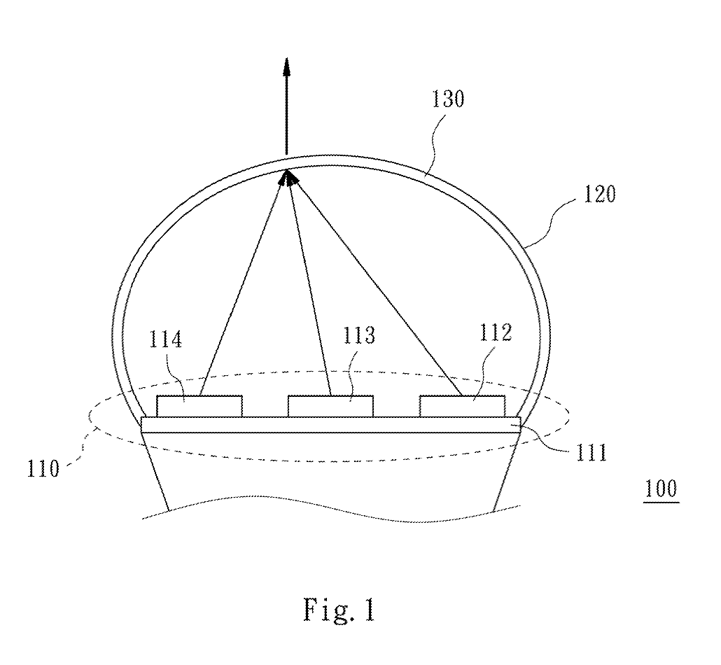

Referring to FIG. 1, FIG. 1 shows an LED lighting device in accordance with a first embodiment of the present invention. The LED lighting device comprises an LED module 110, a lamp cover 120, and a phosphor layer 130. The LED module 110 comprises a circuit board 111 comprising a driving circuit (which can be implemented by using conventional skills and thus is not shown in FIG. 1) and a plurality of LEDs 112-114 (or more) which is mounted on the circuit board 111 and driven by the driving circuit so as to emit light of 300-700 nm in wavelength.

The lamp cover 120 is utilized to enclose the LED module 110, and it is possible to form closed space by vacuum or filling in gas, or an open space, alternatively. The material forming the lamp cover can comprise silicon or plastic, or even Na, K, B, etc. The thickness, size, shape of the lamp cover is adaptive. For example, the shape of the lamp cover may be similar to a circular, an elliptical, a rectangular, a pyramidal, a plate, a tub, a flame, or even a trapezoid. The lamp cover is illustrated as a bulb in this disclosure.

A heat sink (such as a well-known heat sink fin) is usually attached to the circuit 111 to reduce the influence of thermal decay. However, the base of the bulb, such as the well-known an E27, an E26, or an E17, is not shown in FIG. 1.

As for the phosphor layer 130, it is formed by mixing at least two different types of phosphors which absorb light in different spectrums, and coating the phosphors on the lamp cover 120. The ratio of the two phosphors is adjustable with respect to the LEDs. Specifically, the phosphor layer is coated on an inner surface of the lamp cover 120 towards the LED module 110 and configured to transform the light of 300-700 nm in wavelength to a luminary light of 400-700 nm in wavelength. It is understood that, as the LEDs 112-114 are activated the light emitted from the LED module 110 are absorbed by the phosphor layer 130, and the phosphor layer 130 generate luminary light, such as cold white light or warm white light, thereby enabling the LED lighting device to work as a lighting fixture.

The aforementioned LED is not packaged with phosphor in a chip packaging process, and can be a blue LED (ex. InGaN/GaN) emitting light in 445-475 nm wavelength, and/or a red LED (ex. GaP:Zn—O/AlInGaP) emitting light in 615-680 nm wavelength. To form a LED lighting fixture with white color, the light from LED has to be transformed by phosphor. For example, a cold white lighting fixture can be constructed by LEDs emitting 300-500 nm in wavelength and a warm white lighting fixture may be constructed by LEDs emitting light of 300-500 nm in wavelength and some red LEDs emitting light of 630 nm in wavelength.

Some examples of the LEDs suitable for use in the present invention are described as follows:
1. many blue LEDs emitting light in the same spectrum;
2. many blue LEDs emitting light in different spectrums;
3. mixtures of blue LEDs and red LEDs, wherein the LEDs emit light in different colors and spectrums;
4. mixtures of blue LEDs and other LEDs, wherein the LEDs emit light in different colors and spectrums;
5. mixtures of LED chips (each of which is a package including two or more types of LED dies, such as one blue LED die+one red LED die, one blue LED die+two red LED dies, or three LED dies).

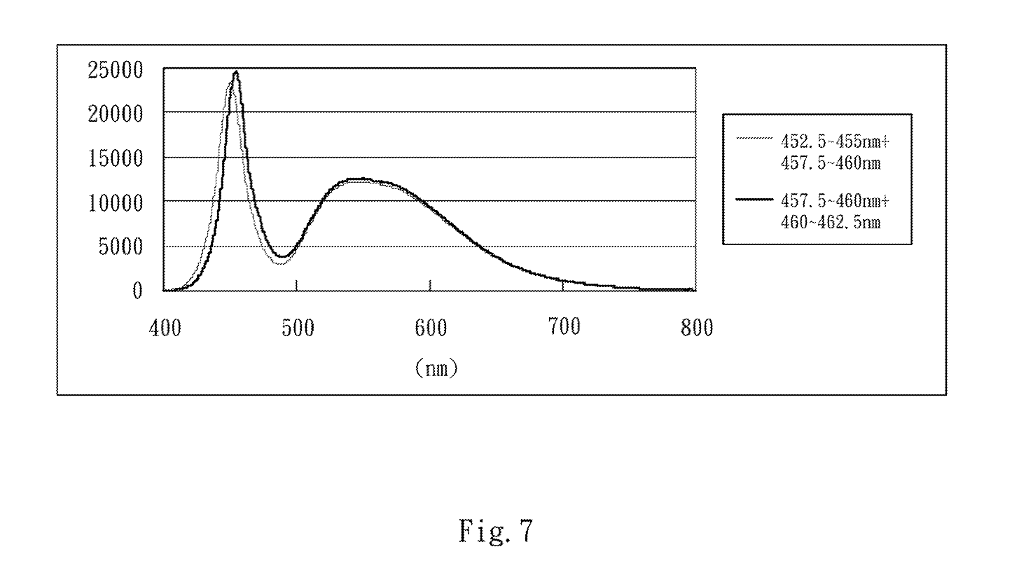

One embodiment of the present invention is shown as the spectrum in FIG. 7, wherein a first group of LEDs emitting light of 452.5-455 nm in wavelength and a second group of LEDs emitting light of 457.5-460 nm in wavelength are selected. Alternatively, it is possible to select a first group of LEDs emitting light of 457.5-460 nm in wavelength and a second group LEDs emitting light of 460-462.5 nm in wavelength.

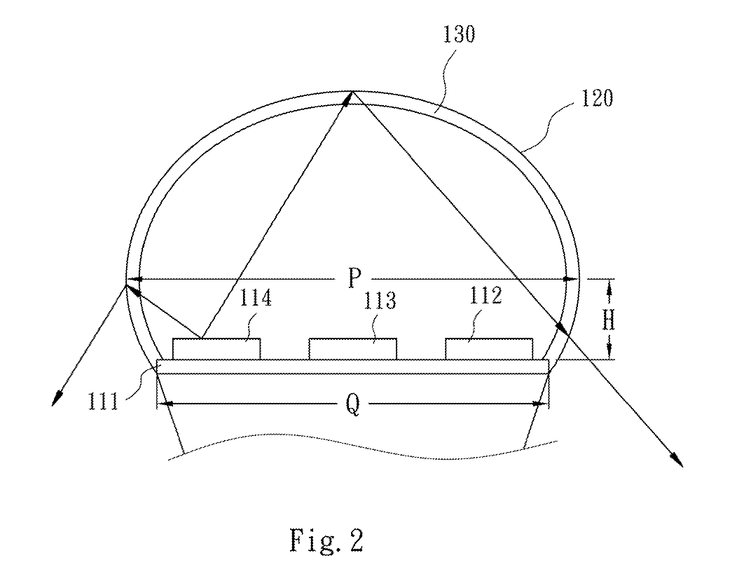

FIG. 2 is a schematic diagram showing an LED lighting device in accordance with a second embodiment of the present invention. According to the second embodiment, the lamp cover 120 is a hemisphere and has a maximum diameter P, and the circuit board 111 of the LED module 110 is a circle corresponding to the lamp cover 120 and has a diameter Q, and H is the distance between P and Q. For an example with the maximum illumination angle, the luminous flux is 700 lm as P=62.5 mm, Q=56 mm, and H=15 mm.

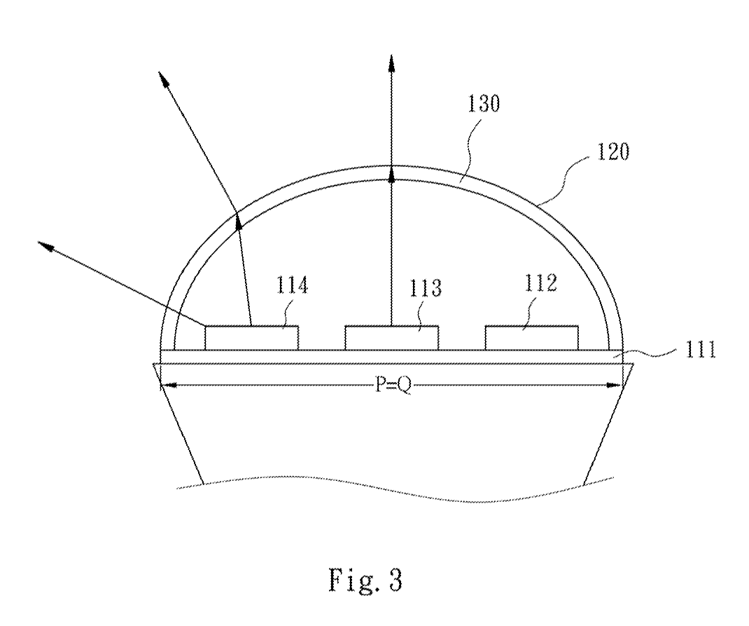

FIG. 3 is a schematic diagram showing an LED lighting device in accordance with a third embodiment of the present invention. According to the third embodiment, the lamp cover 120 is a hemisphere and has a maximum diameter P, and the circuit board 111 of the LED module 110 is a circle corresponding to the lamp cover 120 and has a diameter Q, and H is the distance between P and Q. For an example with the maximum illumination angle, the luminous flux is 520 lm as P=Q=62.5 mm, and H=0 mm.

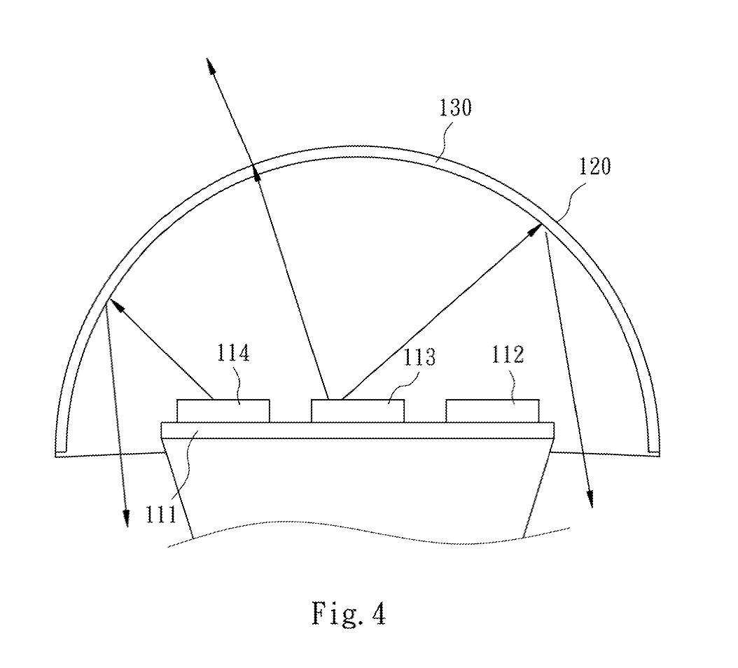

FIG. 4 is a schematic diagram showing an LED lighting device in accordance with a fourth embodiment of the present invention. According to the fourth embodiment, the lamp cover 120 is a hemisphere and has a maximum diameter P, and the circuit board 111 of the LED module 110 is a circle corresponding to the lamp cover 120 and has a diameter Q, and H is the distance between P and Q. When P>Q and H=0 mm, the illumination angle is enlarged due to the unabsorbed light reflected by the uncoated area of the lamp cover.

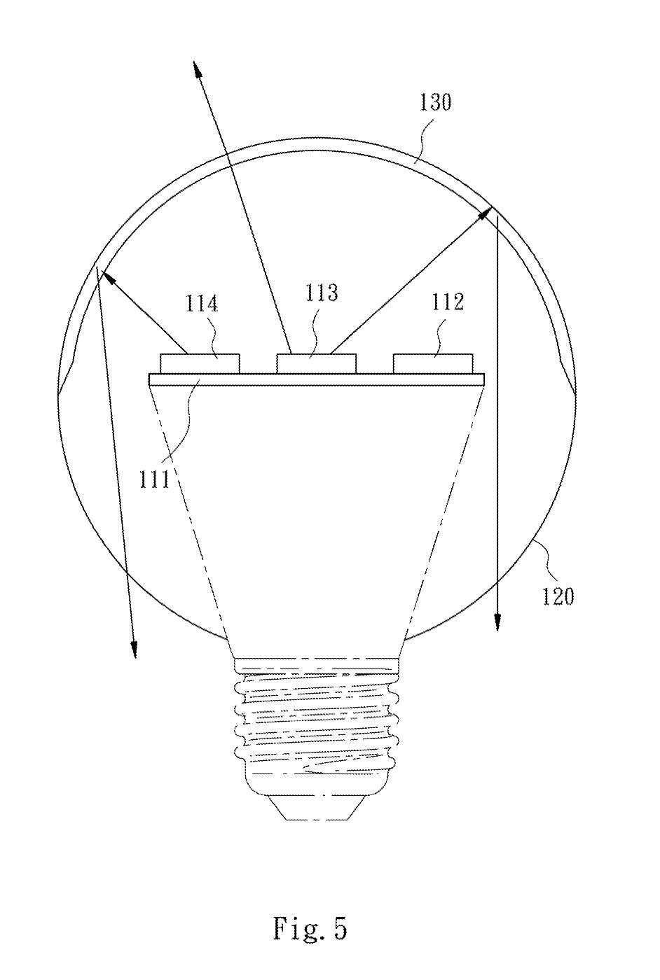

Similarly, FIG. 5 is a schematic diagram showing an LED lighting device in accordance with a fifth embodiment of the present invention. When the lamp cover 120 is a sphere, the phosphor layer 130 is coated on a portion of the lamp cover 120. The uncoated portion of the lamp cover reflects the light to the coated portion of the lamp cover so as to improve the illumination efficiency.

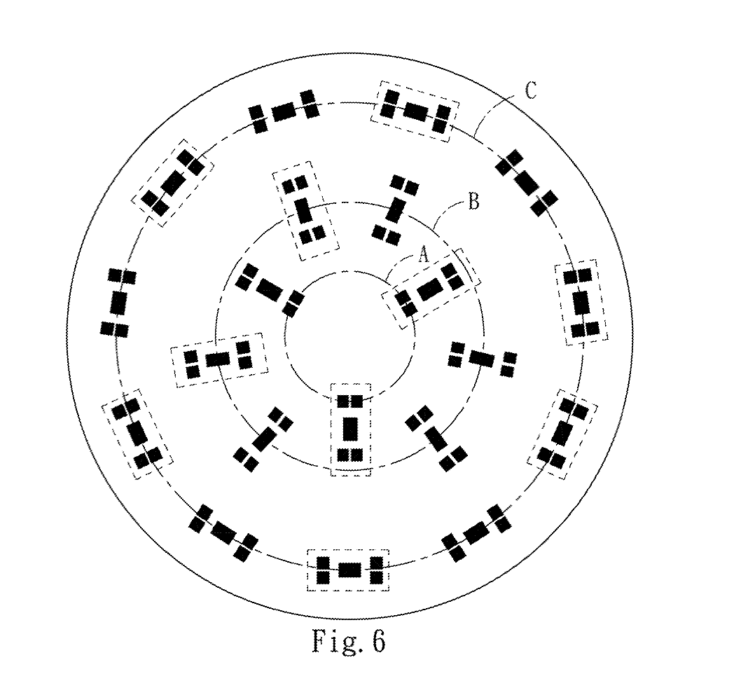

FIG. 6 is a schematic diagram showing the layout of the LEDs on the circuit board applicable to any of the aforementioned embodiments. In FIG. 6, there are three calibrating circles A, B and C. On the circle A, there are three LEDs mounted in a radial symmetrical way. On the circle B, there are six LEDs mounted in a radial symmetrical way. On the circle C, there are eleven LEDs mounted in a radial symmetrical way. On the circle circuit board with 52 mm in diameter, the distribution shown in FIG. 6 can result in a LED lighting fixture with a luminous flux of 700.1 lm, power consumption of 8.47 watts, and efficiency of 82.7 lm/W. In an embodiment of the present invention, the marked LEDs in FIG. 6 can be LEDs emitting light in the same spectrum/color and the other unmarked LEDs can be LEDs emitting light in the same spectrum/color. For example, the marked LEDs may be the first group of LEDs (452.5-455 nm in wavelength), and the unmarked LEDs can be the second group of LEDs (457.5-460 nm in wavelength).

Given in the above, the LED lighting device of the present invention provides a flexible combination of LEDs, the lamp cover and the corresponding phosphor layer, wherein each of the LEDs emits light in different spectrums but in the range of 300-700 nm in wavelength. Thus, a lighting fixture with an arbitrary color can be implemented by using a light source with low cost. In other words, the color of the lighting device is tunable by adjusting the composition of LEDs, the material/ratio of the phosphor, and the space structure.

Although the present invention has been described in considerable detail with reference to certain embodiments thereof, other embodiments are possible. Therefore, the spirit and scope of the appended claims should not be limited to the description of the embodiments contained herein.

What is claimed is:

1. An LED (Light-Emitting Diode) lighting device, comprising:
an LED module comprising:
a circuit board comprising a driving circuit; and
a plurality of LEDs mounted on the circuit board and driven by the driving circuit so as to emit light of 300-700 nm in wavelength;
a lamp cover configured to shield the LED module; and
a phosphor layer coated on an inner surface of the lamp cover towards the LED module and configured to transform the light of 300-700 nm in wavelength to a luminary light of 400-700 nm in wavelength.

2. The LED lighting device of claim 1, wherein the LEDs emit light in different spectrums.

3. The LED lighting device of claim 1, wherein the LEDs comprise at least a blue LED, a red LED or a combination thereof.

4. The LED lighting device of claim 1, wherein the LEDs are mounted in a radial symmetrical way on the circuit board.

5. The LED lighting device of claim 1, wherein the LEDs are mounted on the circuit board at unequal distances.

6. The LED lighting device of claim 1, wherein the driving circuit comprises a current control unit configured to control a current of each of the LEDs so as to adjust a magnitude of the light.

7. The LED lighting device of claim 1, wherein the lamp cover and the LED module form a closed space.

8. The LED lighting device of claim 1, wherein the lamp cover is a hemisphere and has a maximum diameter which is greater than a width of the LED module.

9. The LED lighting device of claim 8, wherein a base of the lamp cover is connected to the circuit board of the LED module.

10. The LED lighting device of claim 8, wherein a center of the lamp cover is located above the circuit board of the LED module.
